(19) United States
(12) Patent Application Publication
(10) Pub. No.: US 2015/0212960 A1
(43) Pub. Date: Jul. 30, 2015

(54) SS HUB, USB 3.0 HUB, AND INFORMATION PROCESSING INSTRUMENT

(71) Applicant: Renesas Electronics Corporation, Kawasaki-shi (JP)

(72) Inventors: Kenichi Ueda, Kanagawa (JP); Tadahiro Watanabe, Kanagawa (JP); Chie Hinoma, Kanagawa (JP)

(21) Appl. No.: 14/586,934

(22) Filed: Dec. 30, 2014

(30) Foreign Application Priority Data
Jan. 24, 2014 (JP) 2014-011379

(51) Int. Cl. G06F 13/38

(52) U.S. Cl. CPC G06F 13/385

(57) ABSTRACT

The power consumption of a USB 3.0 hub is reduced, and the interconnection between the USB 3.0 hub and USB 3.0 devices is improved. On receiving a data transfer request packet, which is transferred by a DS port in a low power consumption state, from a host, an SS controller of an SS hub makes the DS port transmit an LFPS for returning a destination device of the data transfer request packet to U0 state, and transmits a transfer enable packet, which is generated by the SS controller itself and shows that the destination device has become ready to correspond to the data transfer, to the host after transmitting a transfer deferment packet to the host. The SS controller does not execute a process that is specified in USB 3.0, and in which a transfer deferment packet is transmitted to the destination device after the DS port return to U0 state.

### CROSS-REFERENCE TO RELATED APPLICATIONS

The disclosure of Japanese Patent Application No. 2014-011379 filed on Jan. 24, 2014 including the specification, drawings and abstract is incorporated herein by reference in its entirety.

### TECHNICAL FIELD

The present invention relates to USB (Universal Serial Bus) 3.0 hubs, and more particularly relates to an SS (Super Speed) hub.

### BACKGROUND

USB 3.0 (refer to Nonpatent Literature 1), which has backward compatibility with USB 2.0, has the transfer rate of the Super Speed (SS) mode, which enables USB 3.0 to perform ultrahigh speed transfer, in addition to the transfer rates of the low speed (LS) mode, the full speed (FS) mode, and the high speed (HS) mode that USB 2.0 has.

FIG. 14 is FIG. 10-3 shown in Nonpatent Literature 1, and shows the topology of USB 3.0. As shown in FIG. 14, blocks for SS (Super Speed) portions are respectively added to the circuit blocks of USE 3.0 apparatuses (a host, a hub, and a device) while blocks of USB 2.0 (Non-Super Speed portions) are also respectively installed in the circuit blocks of the USB 3.0 apparatuses. For example, a USB 3.0 hub includes two hubs, that is, an SS (Super Speed) hub and a US 2.0 hub.

The SS portion of USB 3.0 that have a physical layer different from that of USB 2.0 inherits many parts of a higher-level protocol layer from USB 2.0 in order to maximally utilize the resources of USB 2.0, and uses existing class drivers as they are in an application layer. In order to fill in a gap between the physical layer that is different from that of USB 2.0 and the protocol layer that is not so much different from that of USB 2.0, a new link layer in charge of packet framing, link establishment, power management, and the like is added to USB 3.0.

FIG. 15 is a hierarchical model diagram of a USB 3.0 apparatus. As shown in FIG. 15, a USB 3.0 apparatus 10 includes an SS portion 30 that is added in accordance with USB 3.0, a USB 2.0 portion 40, and a common portion 20 that is shared by both SS portion 30 and USB 2.0 portion 40. The USB 2.0 portion 40 includes a USB 2.0 controller (HS/FS/LS End Point Controller) 42; a UTMI (USB 2.0 Transceiver Macrocell Interface) 44; and an HS/FS/LS physical layer 46, while the SS portion 30 includes an SS controller (SS End point Controller) 32; a link layer (SS Link) 34; and an SS physical layer 36.

The link layer 34 in FIG. 15 is a link layer that is added to realize SS mode in USB 3.0. Some states are defined in the SS link layer and transition conditions of the states are specified. Parts relevant to the present invention will be explained with reference to FIG. 16.

FIG. 16 is FIG. 7-13 in Nonpatent Literature 1, and depicts the LTSSM (Link Training and Status State Machine) in USB 3.0.

Among power states, U0 state (a normal operation state) is a state in which data can be transmitted or received, and the transmission/reception of packets can be performed in this state. U1 state and U2 state are states in which power consumption is low, and the transmission/reception of packets cannot be performed. Return from U1 state or from U2 state to U0 state is performed via Recovery state.

With reference to FIG. 17 and FIG. 18, in the case where a host transmits a data transfer request packet to a USB 3.0 device connected to the downstream port of the SS hub (hereinafter referred to as the DS port) when the device is in a low power consumption state, the operations of the host, the SS hub, and the device will be explained. In this case, it goes without saying that the DS port to which the device is connected is also in the low power consumption state.

The data transfer request packet means a packet that requests the transfer of a data packet or a part of the packet. In the case of an IN transfer, the data transfer request packet is an ACK TP (Acknowledge Transaction Packet), and in the case of an OUT transfer, the data transfer request packet is a DPH (Data Packet Header). The IN transfer is transfer in which a data packet is transmitted to the host, and the OUT transfer is transfer in which a data packet is transmitted from the host.

In the following descriptions and figures, a “host”, a “hub”, and a “device” respectively mean a “USB 3.0 host”, a “USB 3.0 hub”, and a “USB 3.0 device” unless otherwise specified.

FIG. 17 shows the case of an IN transfer. As shown in FIG. 17, when the host issues a transfer request packet to the device (at step S1), the hub makes the DS port transmit a return signal LFPS (Low Frequency Period Signal) for returning the DS port and the device to U0 state (at step S2), and at the same time, the hub transmits a transfer deferment packet (a first transfer deferment packet in FIG. 17), which informs the host of the deferment of data transfer, to the host (at step S3). Subsequently, after the DS port and the device return to U0 state, the hub transmits a transfer deferment packet that shows the deferment of data transfer (a second transfer deferment packet in FIG. 17) to the device (at step S4). Here, a dotted-line arrow showing the LFPS is proceeding from the hub to the device, and this means that the device eventually returns to U0 state through the transmission/reception of a low frequency signal, that is to say, the LFPS.

In response to the second transfer deferment packet, the device transmits a transfer enable packet indicating that the device is ready to correspond to the requested data transfer to the hub (at step S5).

The transfer enable packet is transferred to the host by the hub (at step S6), and the host issues a transfer request packet again in response to the transfer enable packet as is the case with step S1 (at step S7). The transfer request packet is transferred to the device by the hub (at step S8), and subsequently a data packet is transmitted from the device to the host (at step S9 and step S10).

The processes executed by the hub at step S2 to step S4 will be collectively referred to as the “transfer deferment processing” hereinafter. Here, since FIG. 17 shows an example of an IN transfer, all the packets except for the data packet are Transaction Packets (TPs). In USB 3.0, a TP has only a header, and does not have a payload. The detail of a TP will be described later.

FIG. 18 shows the case of an OUT transfer. As shown in FIG. 18, a packet including a transfer request packet and data to be transmitted itself is transmitted by the host at step S1′. The header of the packet corresponds to the transfer request packet, and the payload of the packet corresponds to the transfer data itself.

Step S2 is the same as step S2 shown in FIG. 17. The hub discards the DPP of a packet the hub received at step S1′ and sets Deferred bit of the DPH of the packet to “1”, then the hub transmits the modified packet to the host and the device as a transfer deferment packet (at step S3′ and step S4′). As is the case with step S5 and step S6 in FIG. 17, the device transmits a transfer enable packet to the hub (at step S5), and the transfer enable packet is transferred to the host by the hub (at step S6). At step S7′, the host transmits a packet that is similar to the packet transmitted at step S1′ to the hub, and the packet is transferred to the device by the hub.

In the case shown in FIG. 18, all the packets except for the packets that are DPHs at step S3′ and at step S4′ and the packets at step S1′, step S7′, and step S8′ are TPs.

FIG. 19 is FIG. 8-2 shown in Nonpatent Literature 1, and shows the format of a TP. With reference to FIG. 19, the contents of a transfer request packet, a first transfer deferment packet, a second transfer deferment packet, and a transfer enable packet shown in FIG. 17 and FIG. 18 will be described.

In the case of the transfer request packet, “Device Address” is the address of a destination device, and “Route String” is information indicating a transfer route of the TP.

The first transfer deferment packet transmitted to the host and the second transfer deferment packet transmitted to the device are equal to each other, and they are generated from the transfer request packet (from a TP or a DPH). In the case of the OUT transfer, a DPP is discarded. To put it concretely, the hub generates the transfer deferment packet by modifying “Link Control Word” of the transfer request packet. This will be explained with reference to FIG. 20.

FIG. 20 is FIG. 8-3 shown in Nonpatent Literature 1, and shows the format of “Link Control Word” part of a TP. The “DF (Deferred)” bit shown in FIG. 20 can be set only by the hub. In other words, the DF bit is not set in the transfer request packet transmitted from the host. In the case of a DPH, the DF bit is not set in a similar way.

The hub generates the first transfer deferment packet and the second transfer deferment packet by setting the DF bit of “Link Control Word” of the transfer request packet.

In USB 3.0, the transfer enable packet is referred to as an Endpoint Ready (ERDY) TP. FIG. 21 shows the format of the Endpoint Ready (ERDY) TP. Here, FIG. 21 is FIG. 8-13 shown in Nonpatent Literature 1.

In the transfer enable packet, “Device Address” is set to the address of a source device itself, and “Sub Type” is set to “ERDY”. In addition, “NumP” is set to the number of buffers that the device can transmit.

Nonpatent Literature 1: Universal Serial Bus 3.0 Specification (including errata and ECNs through May 1, 2011), Revision 1.0, Jun. 6, 2011

### SUMMARY

As described above, if a DS port of the hub and a device connected to the DS port are in the low power consumption state (in U1 state or U2 state), it is necessary that the DS port and the device should return to U0 state, and at the same time, it is necessary that TPs and DPHs should be exchanged among the host, the hub, and the device until a data packet can be exchanged between the DS port and the device.

It is nothing unusual that a host, a hub, and a device in a system are individually made by different manufacturers. In this case, unless developers of each manufacturer develop their product in conformity with the USB 3.0 specification, the system breaks down. On the other hand, it sometimes happens that individual developers make interpretations of the details of the USB 3.0 specification differently on the basis of their own skills.

For example, there are some USB 3.0 devices in which step S5 shown in FIG. 17 is not executed. In this case, there arises a problem in interconnection between the hub and the device such as the stoppage of USB communication owing to a deadlock.

Although there are some where measures are taken to avert this problem in such a way that a DS port of a USB 3.0 hub is prevented from transferring to the low power consumption state, it has been found that the power consumption of a USB 3.0 hub can be reduced about 20% to 30% if the DS port of the USB 3.0 hub is transferred to the low power consumption state, with the result that preventing the DS port from transferring to the low power consumption state makes it impossible to realize a low power consumption type USB 3.0 hub.

Other problems of the related arts and new features of the present invention will be revealed in accordance with the description of the present specification and the accompanying drawings hereinafter.

One aspect of the present invention is an SS hub installed in a USB 3.0 hub, and the SS hub includes one or more DS ports and an SS controller. Hereinafter, a USB 3.0 apparatus that is directly connected to a DS port of an SS hub will be referred to as a “directly-beneath type apparatus”. Here, a USE 3.0 hub and a USB 3.0 device are directly-beneath type apparatuses.

When the SS controller receives a transfer request packet, which requests a destination device that is a downstream USE 3.0 device (hereinafter referred to as the “object device”) to transmit data, from the host, if a DS port that is in charge of transmitting the transfer request packet downstream among the one or more DS ports, and a USE 3.0 apparatus directly connected to the DS port (hereinafter referred to as the directly-beneath type apparatus) are in a low power consumption state, that is, in U1 state or in U2 state, the SS controller executes only part of processes specified by the USB 3.0 specification and processes that are not specified by the USB 3.0 specification.

To put it concretely, the SS controller executes a process for making the DS port transmit an LFPS (Low Frequency Period Signal) for returning the DS port and the directly-beneath type apparatus to U0 state, and a process for transmitting the first transfer deferment packet, which informs the host of the deferment of the data transfer, to the host.

On the other hand, after the DS port and the directly-beneath type apparatus return to U0 state, the SS controller does not execute a process in which a second transfer deferment packet indicating the deferment of the data transfer is transmitted to the object device among processes specified in USB 3.0.

A process that is not specified in USB 3.0 but executed by the SS controller is a process in which a transfer enable packet indicating that the object device has become ready to correspond to the data transfer is generated by the SS controller by itself and the transfer enable packet is transmitted to the host after the first transfer deferment packet.

In addition, hardware or software in which the SS hub according to the above aspect of the present invention is replaced with a device or a method, an USB 3.0 hub that includes the SS hub, and an information processing instrument including the USB 3.0 hub, and the like are also functional as other aspects of the present invention.

According to the above aspect of the present invention, the power consumption of the USB 3.0 hub can be suppressed, and at the same time, interconnection between the USB 3.0 hub and USB 3.0 devices can be strengthened.

### BRIEF DESCRIPTION OF THE DRAWINGS

FIG. 1 is a block diagram showing an SS hub according to a first embodiment of the present invention.

FIG. 2 is a flowchart showing an example of an IN transfer operation of the SS hub shown in FIG. 1.

FIG. 2 is a flowchart showing an example of an OUT transfer operation of the SS hub shown in FIG. 1.

FIG. 4 is a block diagram showing an SS hub according to a second embodiment of the present invention.

FIG. 5 is a diagram of the Set Hub Depth request.

FIG. 6 is a diagram showing the format of Route String.

FIG. 7 is a diagram showing an example of Route String.

FIG. 8 is a flowchart showing the operation of a judgment circuit of the SS hub shown in FIG. 4.

FIG. 9 is a block diagram showing an SS hub according to a third embodiment of the present invention.

FIG. 10 is a flowchart showing an example of an IN transfer operation of the SS hub shown in FIG. 9.

FIG. 11 is a flowchart showing an example of an OUT transfer operation of the SS hub shown in FIG. 9.

FIG. 12 is a block diagram showing a USB system according to a fourth embodiment of the present invention.

FIG. 13 is a block diagram showing a compound device according to a fifth embodiment of the present invention.

FIG. 14 is a diagram showing the topology of USB 3.0.

FIG. 15 is the hierarchy model diagram of a USB 3.0 apparatus.

FIG. 16 is a diagram showing the LTSSM state transition specified in USB 3.0.

FIG. 17 is a diagram for explaining examples of the operations of a host, a hub and a device when the power state between the hub and the device is a low power consumption state (in the case of an IN transfer).

FIG. 18 is a diagram for explaining examples of the operations of a host, a hub and a device when the power state between the hub and the device is a low power consumption state (in the case of an OUT transfer).

FIG. 19 is the format of a TP (Transaction Packet).

FIG. 20 is the format of Link Control Word of a TP.

FIG. 21 is the format of a transfer enable packet (ERDY TP).

### DETAILED DESCRIPTION

The following descriptions and drawings will be arbitrarily omitted or simplified for the sake of clear explanation. In addition, the same elements in the attached drawings are denoted by the same reference numerals, and redundant explanations thereof will be omitted accordingly. Signals and packets that are transmitted or received between functional blocks are also shown diagrammatically only when needed for explanation.

### First Embodiment

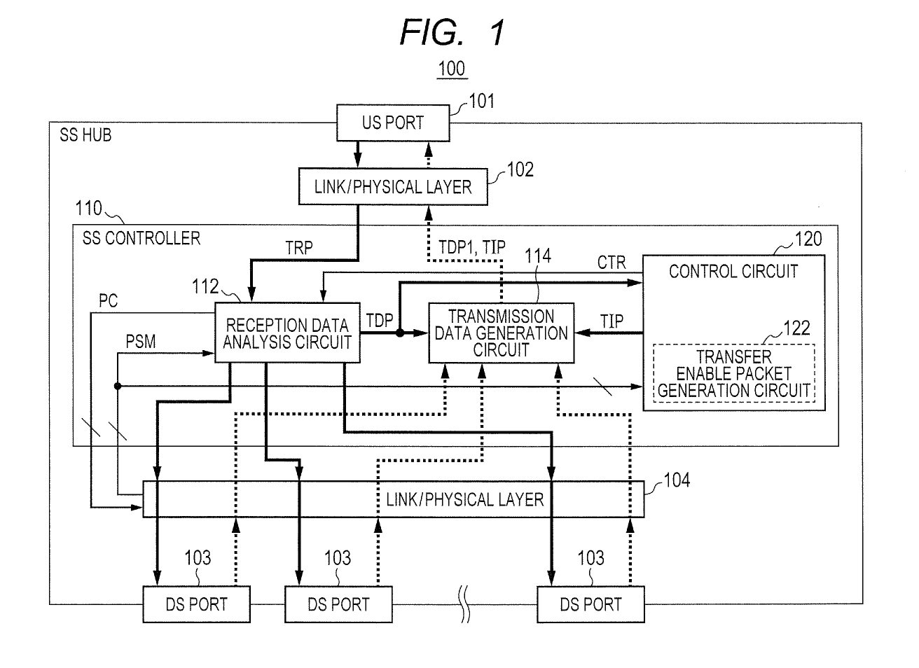

FIG. 1 shows is a block diagram showing an SS hub 100 according to a first embodiment of the present invention. The SS hub 100 is a Super Speed hub included in a USB 3.0 hub, and includes an Upstream port 101 (hereinafter referred to as the US port 101) used for the SS hub 100 to be connected to an upstream USB 3.0 host or to the USB 3.0 hub; a link/physical layer 102 that executes processes for a link layer and a physical layer corresponding to the US port 101; one or more Downstream ports 103 (hereinafter referred to as the one or more DS ports 103 each of which is used for the SS hub 100 to be connected to a downstream USE 3.0 hub or to a USB 3.0 device; a link/physical layer 104 that executes processes for a link layer and a physical layer corresponding to each of the one or more DS ports 103; and a Super Speed controller 110 (hereinafter referred to as the SS controller).

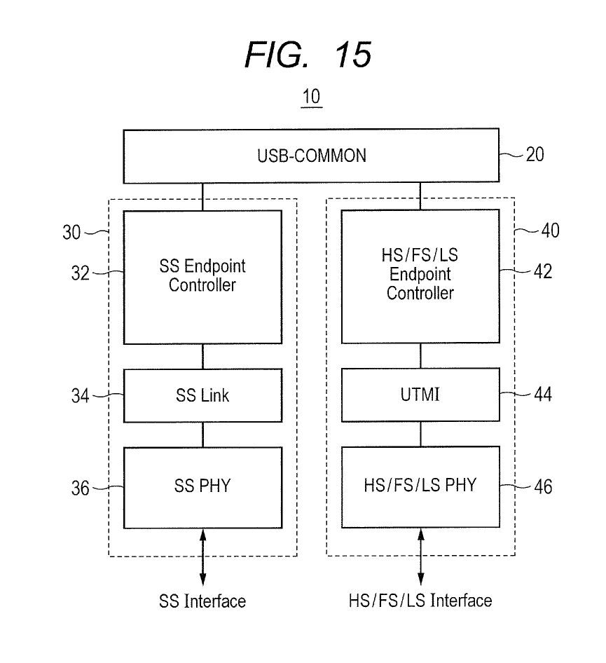

The SS controller 110 corresponds to an SS controller 32 in the case where the USB 3.0 apparatus 10 shown in FIG. 15 is a hub, and includes a reception data analysis circuit 112, a transmission data generation circuit 114, and a control circuit 120. The control circuit 120 includes a transfer enable packet generation circuit 122.

The US port 101, the link/physical layer 102, the one or more DS ports 103, and the link/physical layer 104 are respectively the same as corresponding functional blocks in a normal SS hub, therefore explanations thereof will be omitted.

In the SS controller 110, the reception data analysis circuit 112 analyzes route information of a transfer request packet TRP transmitted from the host via the US port 101 and the link/physical layer 102, and determines a DS port that is in charge of transferring the transfer request packet TRP downstream among the one or more DS ports.

At this time, the reception data analysis circuit 112 checks the power state of the determined DS port, and if the determined DS port is in a low power consumption state, that is, in U1 state or U2 state, the reception data analysis circuit 112 generates a transfer deferment packet TDP by setting “DF (Deferred)” bit of the transfer request packet TRP, and outputs the transfer deferment packet TDP to the transmission data generation circuit 114 and the control circuit 120. In addition, the power state of each DS port is conveyed to the reception data analysis circuit 112 from the link/physical layer 104 using a power state monitor signal PSM.

The transmission data generation circuit 114 transmits the transfer deferment packet TDP to the host as a first transfer deferment packet TDP1 from the US port 101 via the link/physical layer 102.

In addition, the reception data analysis circuit 112 outputs a power control signal PC to the link/physical layer 104 so that the determined DS port transfers from the low power consumption state to U0 state that is a normal operation state.

The link/physical layer 104 makes the above DS port 103 transmit an LFPS, which is a low frequency signal, in response to the above power control signal PC so that the determined DS port is transferred from the low power consumption state to U0 state.

In the control circuit 120, the transfer enable packet generation circuit 122 generates a transfer enable packet TIP by changing the contents of some fields of the transfer deferment packet TDP generated by the reception data analysis circuit 112. To put it concretely, the content of the field Sub Type is changed into ERDY and the values of unnecessary fields are set to “0”. Further, the “NumP” field of the transfer enable packet TIP is set to the minimum buffer number “1”.

The control circuit 120 outputs the transfer enable packet TIP generated by the transfer enable packet generation circuit 122 to the transmission data generation 114 after the transmission data generation circuit 114 transmits the first transfer deferment packet TDP1 to the host, and then the control circuit 120 controls the transmission data generation circuit 114 to transmit the transfer enable packet TIP to the host.

In addition, the control circuit 120 outputs a control signal CTR to the reception data analysis circuit 112 lest the reception data analysis circuit 112 should transmit a transfer deferment packet (a second transfer deferment packet) to the DS port.

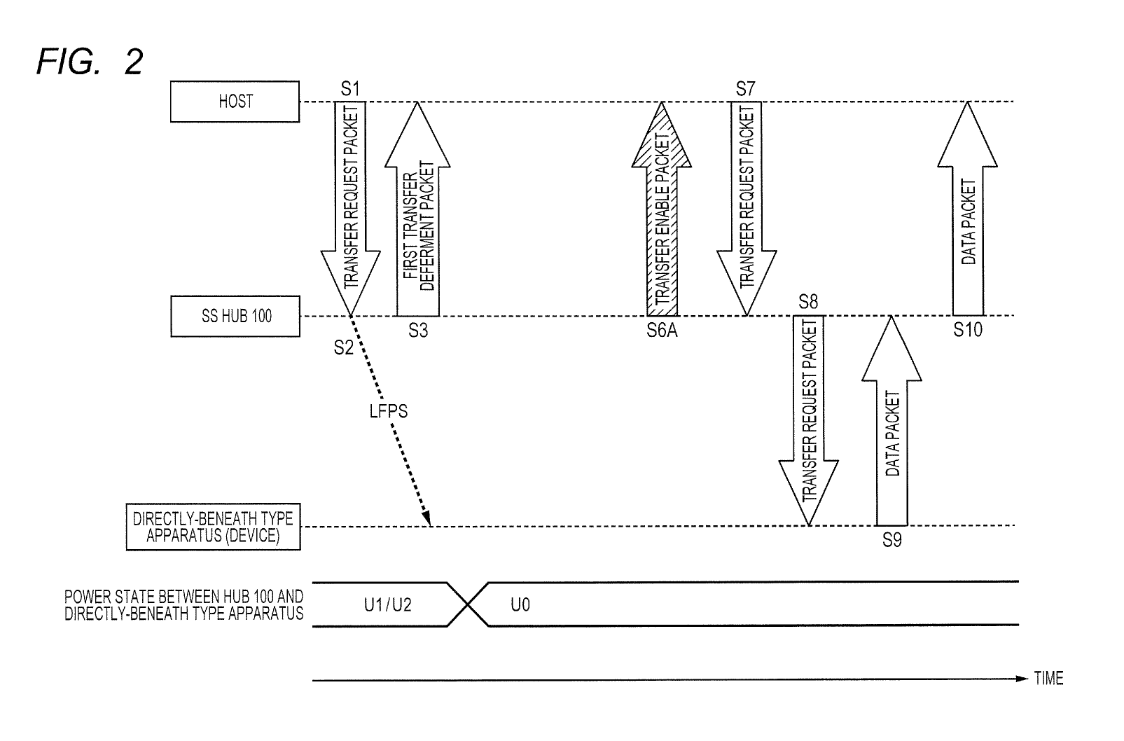

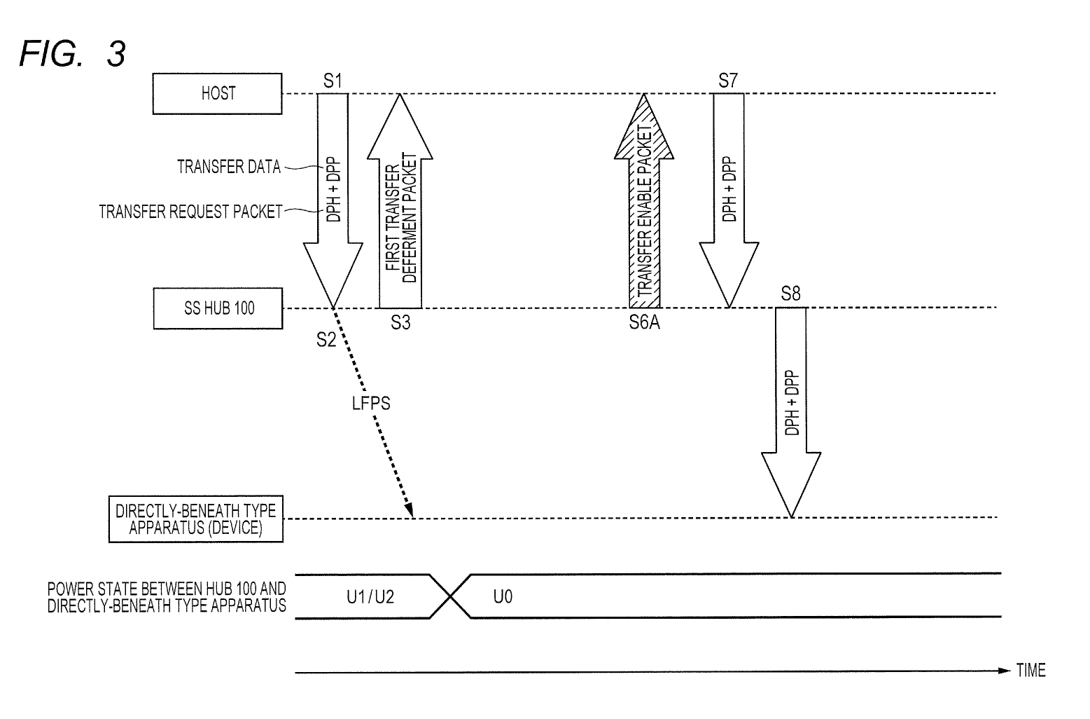

FIG. 2 is a flowchart showing the operation of the SS hub 100 in the case where a device is directly connected to the DS port 103 in an IN transfer, and FIG. 3 is a flowchart showing the operation of the SS hub 100 in the case where a device is directly connected to the DS port 103 in an OUT transfer. As mentioned above, a USB 3.0 apparatus directly connected to a DS port of the hub is referred to as a “directly-beneath type apparatus”.

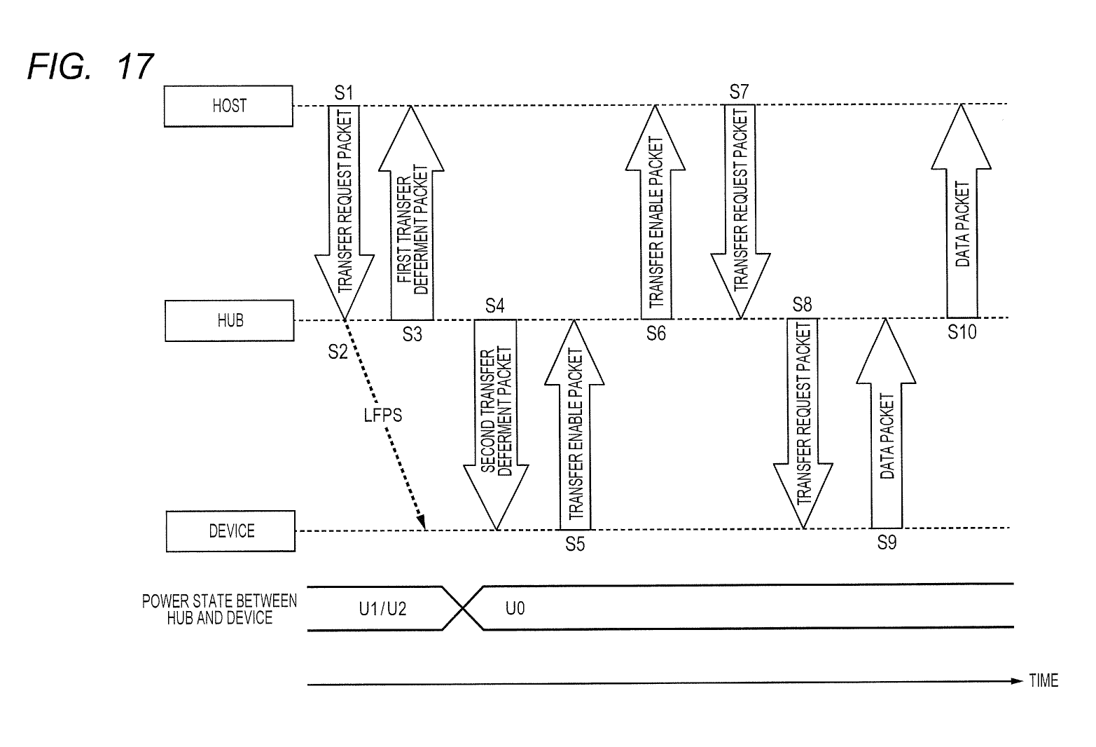

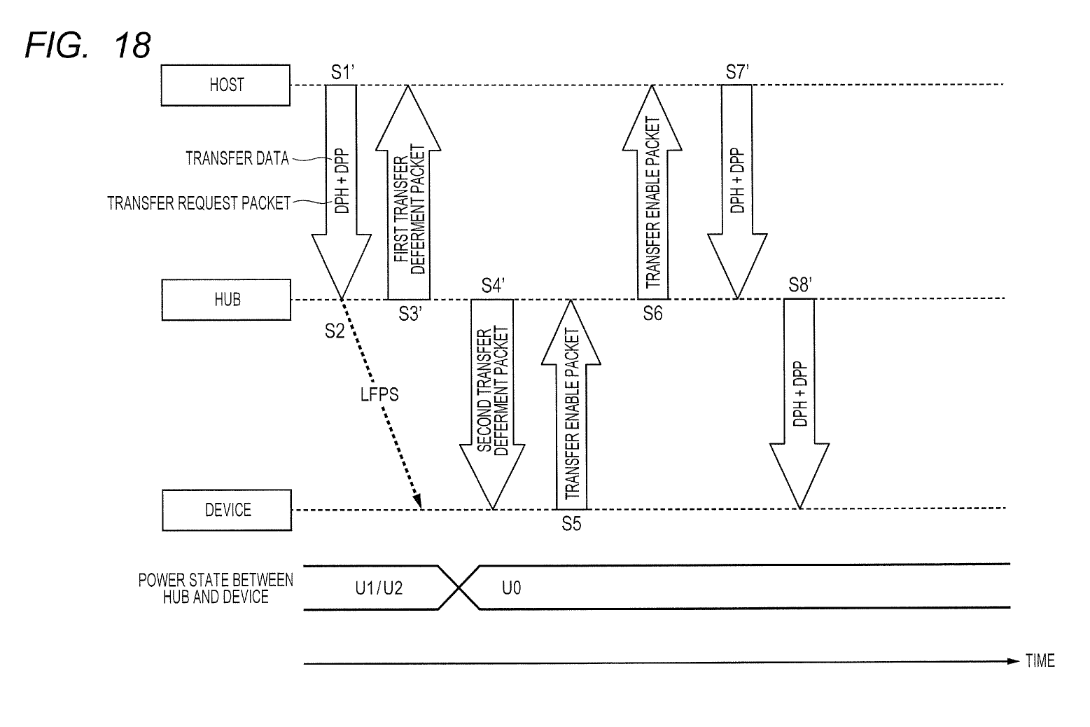

As is clear by comparing FIG. 2 and FIG. 17 with each other or by comparing FIG. 3 and FIG. 18 with each other, the SS hub 100 of this embodiment does not execute step S4 or step S4′ (transmission of the second transfer deferment packet) in FIG. 17 or FIG. 18 although both step 4 and step 4′ are specified by the USB 3.0 specification. Therefore, the SS hub 100 also does not execute the step for receiving the transfer enable packet from a device (step S5), and a transfer enable packet, which the SS hub 100 transmits to the host at step S6A, is one that is generated by the SS hub by itself.

According to the SS hub 100 of this embodiment, during the time period from the time when a DS port and a device connected to the DS port are in the low power consumption state to the time when a data packet can be exchanged between the host and the device that is a directly-beneath type apparatus, it is not necessary for any TP to be exchanged between the hub and the device. Therefore, a problem of interconnection caused owing to a failure that the device cannot deal with a transfer deferment packet normally can be prevented from occurring. Further, since the exchange of the TPs is not needed, the efficiency of transfer is improved and power consumption is more reduced.

Here, it is considered that a timing in which the SS hub transmits the transfer enable packet to the host. It is preferable that this timing should come after the LFPS and the first transfer deferment packet are transmitted, and there are some artifices from various view points.

For example, in order to increase the probability of the destination device (object device) having been ready to correspond to the requested data transfer when the host issues a transfer request packet again, it is conceivable that the transfer enable packet is transmitted to the host at the time when the DS port and the directly-beneath type apparatus returns to U0 state. Here, since there may be a configuration in which a hub is connected to the DS port of the SS hub and an object device is connected under the hub, the object device is not necessarily a directly-beneath type apparatus of the SS hub 100.

Alternatively, in order to rapidly execute the exchange of a data packet, it is conceivable, for example, that the transfer enable packet is transmitted to the host in the timing when the DS port and the directly-beneath type apparatus return to Recovery state.

Further, it is also conceivable that the transfer enable packet is transmitted to the host when a predefined time elapses after the first transfer deferment packet is transmitted to the host.

This predefined time can be obtained using a technology such as simulation or real instrument measurement so that the efficiency of transfer may be improved.

For example, the maximum time (referred to as T1) from the time when be hub transmits the LFPS to the time when the device returns to U0 state is already conveyed to the host by the device when the device was connected to the host. When the hub transfers this information to the host, the hub reserves this information inside itself. The minimum time (referred to as T2) from the time when the host receives the transfer enable packet to the time when the host transmits a transfer request packet again depends on the capability of the host. However, since the minimum time can be checked by evaluation using a real instrument, it is necessary to record this checked minimum time in a register in the hub. When the hub transmits the LFPS, a timer is automatically started, and after the time “T1-T2” elapses, the hub transmits the transfer enable packet which is generated by the hub itself to the host.

As for a value to which “NumP” of a transfer enable packet generated by the transfer enable packet generation circuit 122 is set, it is conceivable that the value of NumP included in the transfer enable packet issued lastly by the device is reserved, and when the transfer enable packet generation circuit 122 issues a transfer enable packet instead of the device, not a fixed value “1” but, for example, the reserved value of NumP is used as the value to which “NumP” of the transfer enable packet is set.

Here, if the device is a device compatible with the USB 3.0 specification, the device does not receive the second transfer deferment packet, but there is no problem. The reason is that, since the hub transmits the transfer enable packet under the above-mentioned condition, the device is already in U0 state and is ready to transmit or receive a packet when the host transmits a transfer request packet again to the device, so that the situation is just the same as that in which a packet is transmitted or received in U0 state from the beginning.

### Second Embodiment

In the case where a destination device (object device) of a transfer request packet that is directed to be transferred via a DS port in a low power consumption state is not a directly-beneath type apparatus directly connected to the DS port, if the technology explained using the first embodiment is applied, there is a possibility that the object device has not returned to U0 state yet when a host issues a transfer request packet again. In order to prevent such a thing from occurring and to improve the efficiency of the system, it is judged whether an object device of a transfer request packet that is directed to be transferred via a DS port in the low power consumption state is a directly-beneath type apparatus of the DS port or not, and it is desirable that, only if the object device is the directly-beneath type apparatus of the DS port, the technology of the first embodiment should be applied, and if the object device is not the directly-beneath type apparatus of the DS port, a transfer deferment process should be executed as specified by the USB 3.0 specification. This method will be explained using a second embodiment. Hereinafter, only points of this second embodiment that are different from those of the first embodiment will be explained.

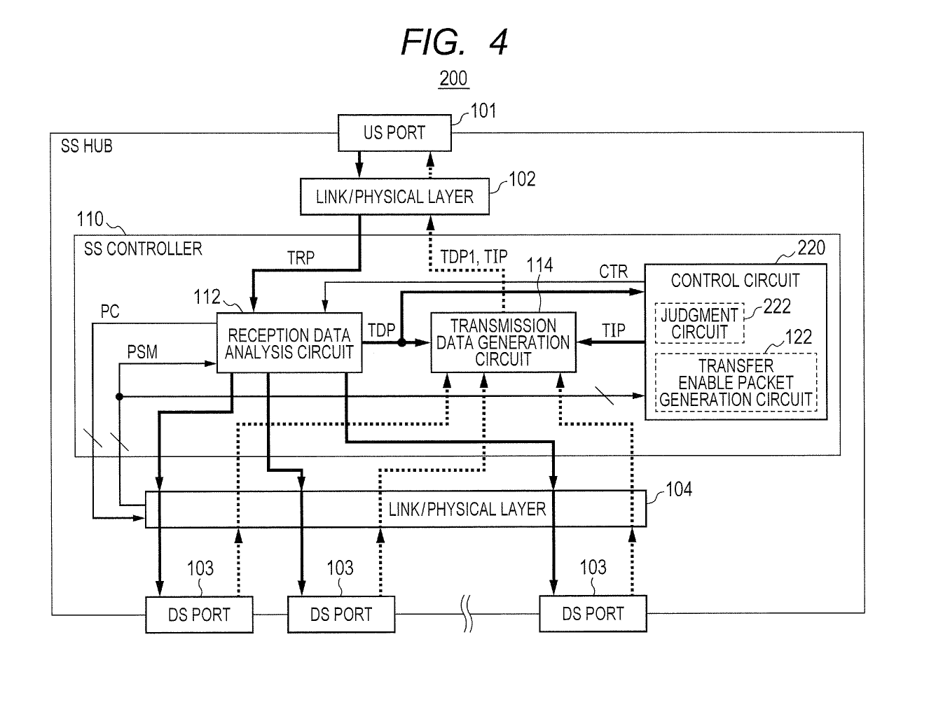

As shown in FIG. 4, an SS hub 200 according to the second embodiment includes a control circuit 220 instead of the control circuit 120 of the SS hub 100. The control circuit 220 is a circuit including the control circuit 120 and a judgment circuit 222 added to the control circuit 120.

The judgment circuit 222 is a circuit for judging whether an object device of a transfer request packet that is directed to be transferred via a DS port in the low power consumption state is a directly-beneath type apparatus of the DS port or not. With reference to the judgment result of the judgment circuit 222, if the object device is the directly-beneath type apparatus, the control circuit 220 controls a transfer deferment process shown in FIG. 2 to be executed, and if the object device is not the directly-beneath type apparatus, the control circuit 220 controls a transfer deferment process shown in FIG. 17 to be executed.

In this embodiment, the judgment circuit 222 judges whether the object device is the directly-beneath type apparatus or not on the basis of Hub Depth of the SS hub 200 and Route String (route information) included in the transfer request packet.

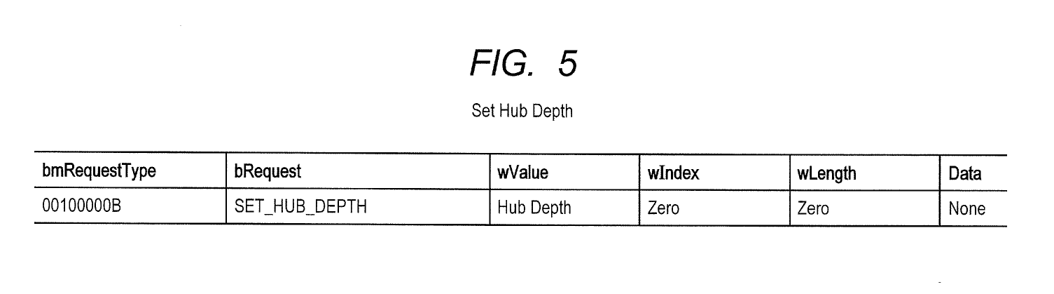

Hub Depth is a value that shows the ordinal number of a tier where the hub is located when counted from a host, and “0” shows that the hub is located in the first tier, “1” shows that the hub is located in the second tier, and so on. Hub Depth is transmitted from a USB 3.0 host to a USB 3.0 hub using the Set Hub Depth request, and is reserved by the USB 3.0 hub itself. The reception data analysis circuit 112 analyzes the request, reserves the analyzed result, and executes updating after the connection check process with the host is completed. Here, FIG. 5 is a figure shown in Section 10.14.2.9 of Nonpatent Literature 1.

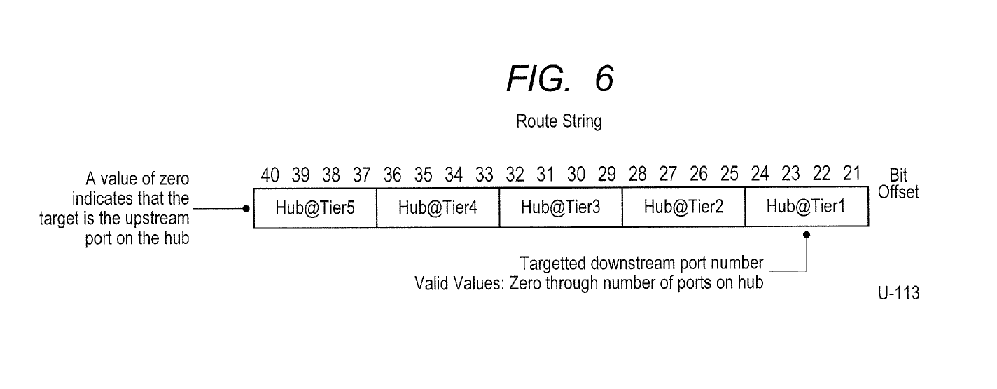

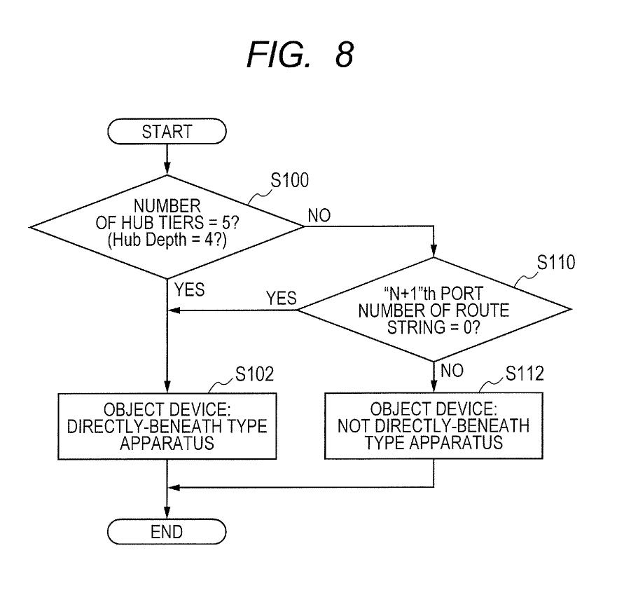

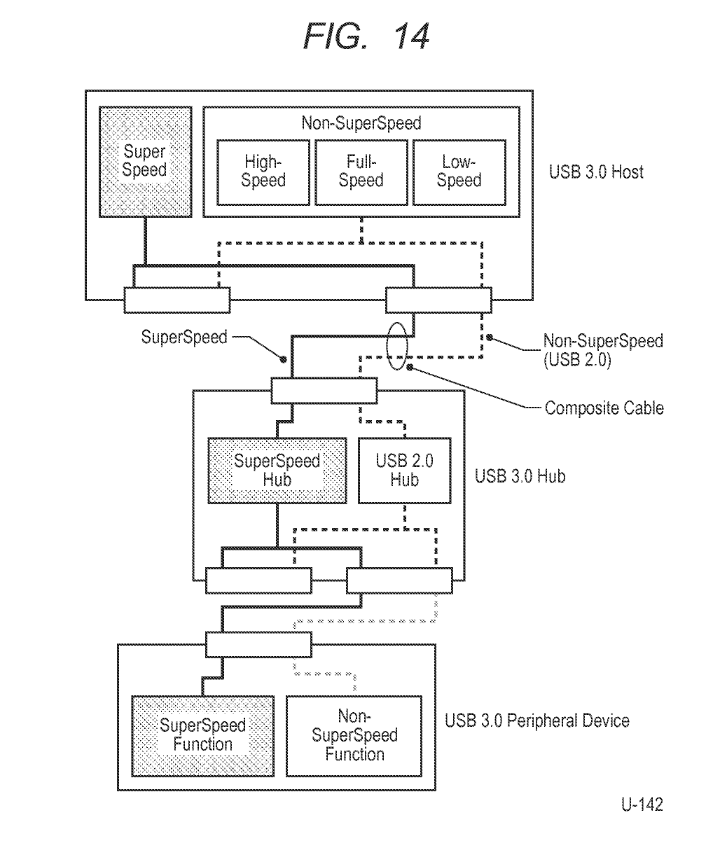

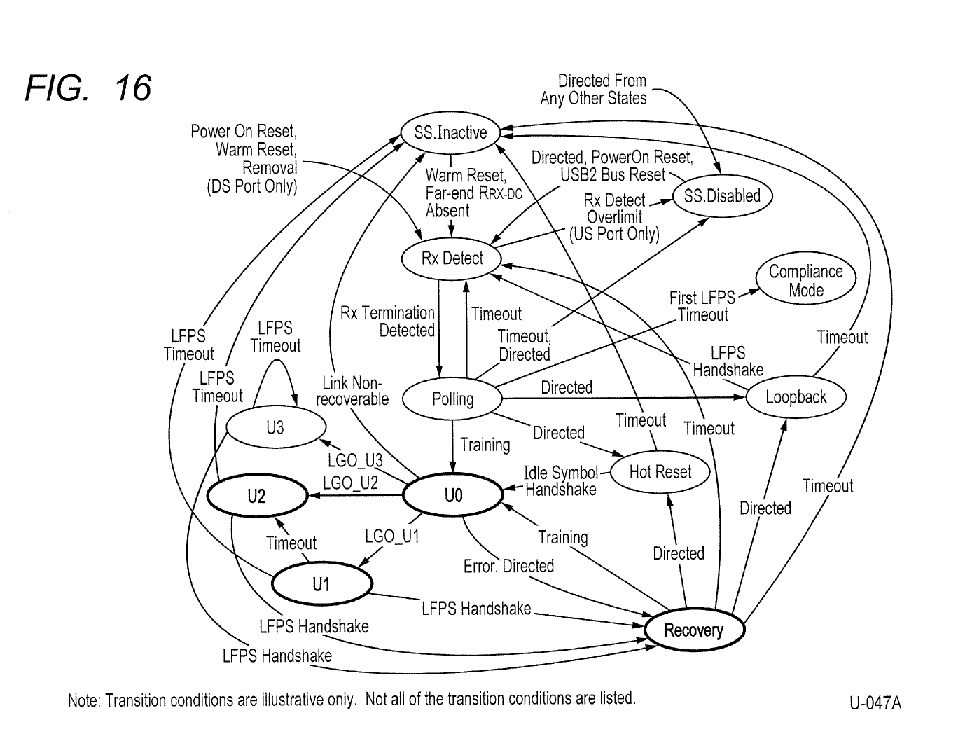

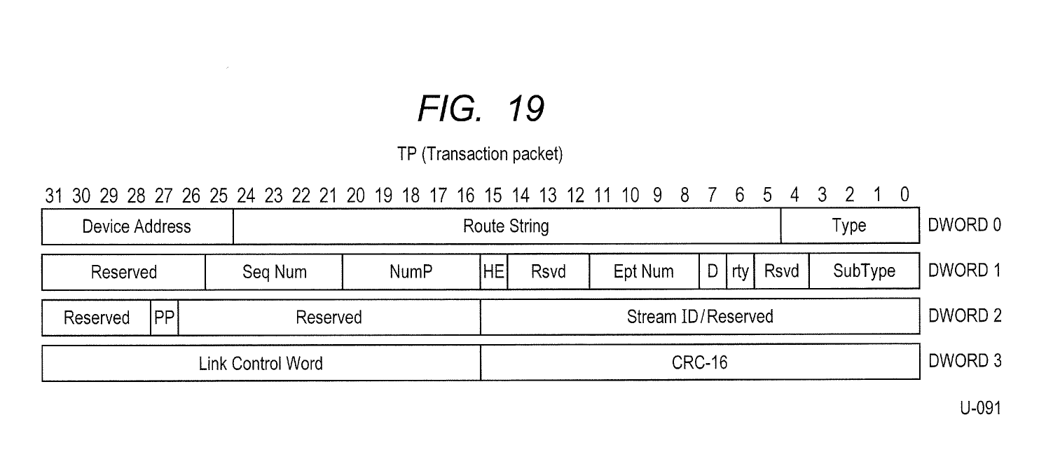

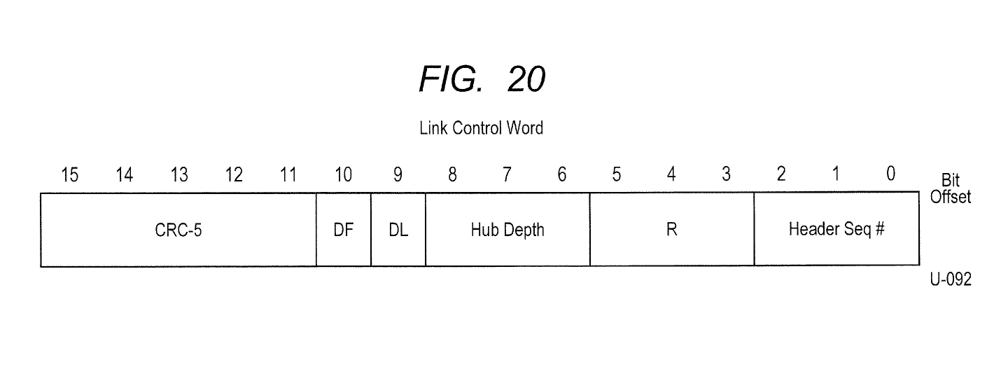

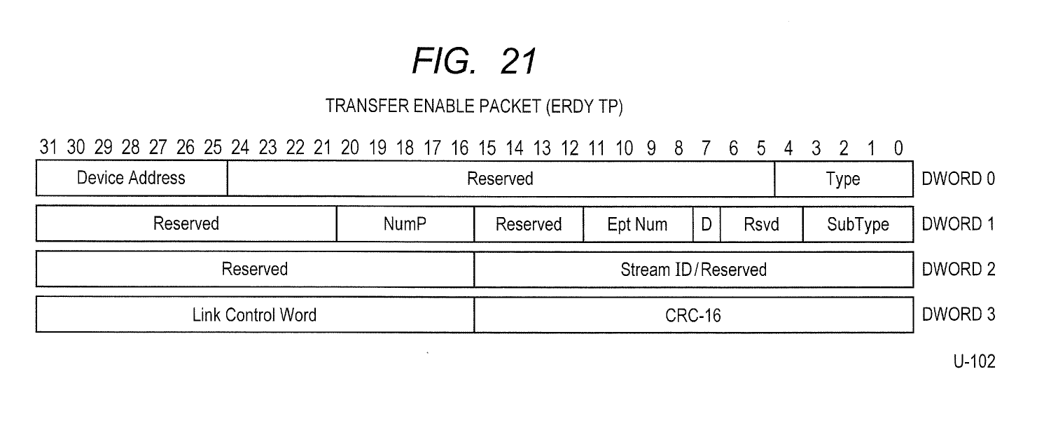

FIG. 6 is FIG. 8-24 shown in Nonpatent Literature 1, and shows the format of route information Route String. Route String shows the DS port numbers of USB 3.0 hubs in individual tiers. The maximum number of the tiers is five and that is specified by the USB 3.0 specification, and the communication route of a packet can be known from Route String.

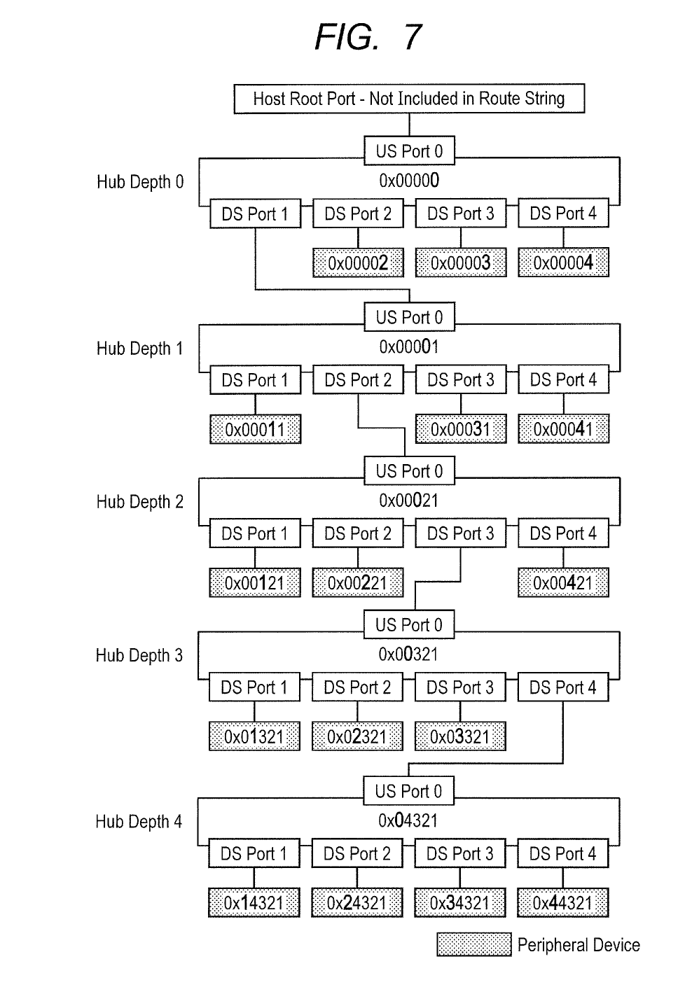

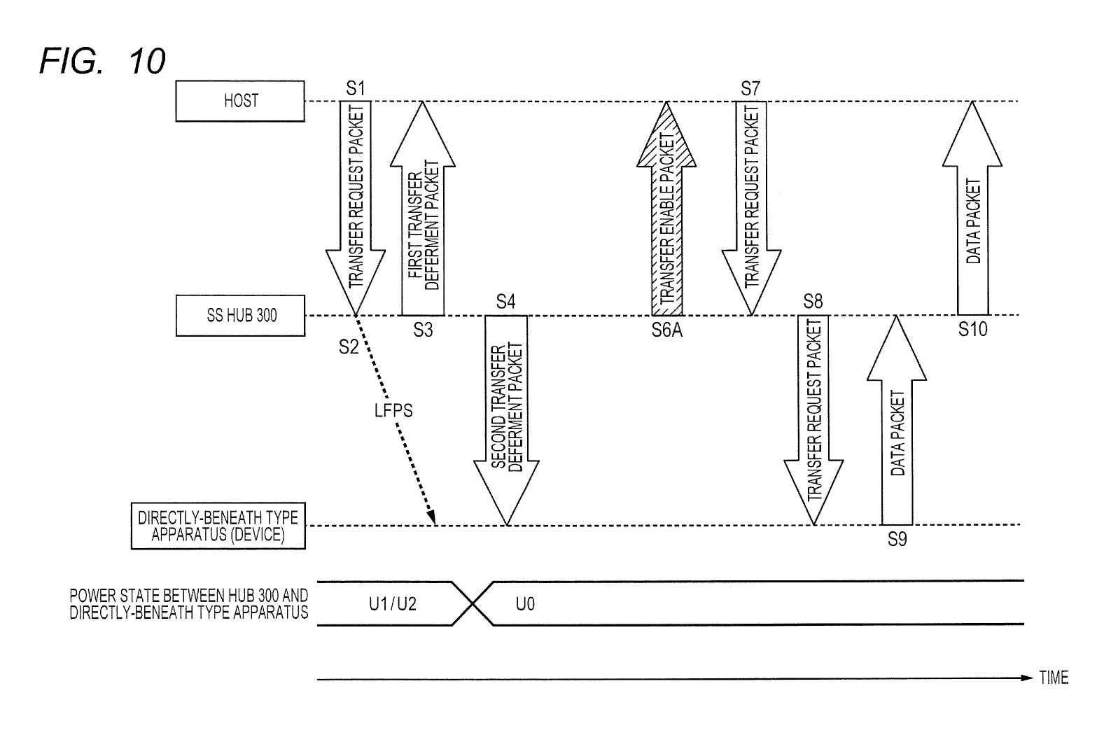

FIG. 7 is FIG. 10-5 shown in Nonpatent Literature 1, and shows an example of Route String. For example, Route String of a packet transmitted to a device connected to the first DS port (DS Port 1) of a hub of the third tier (Hub Depth 2) counted from the host is “0x00121”. This means that the transfer route of the device is a route “from the first DS port of the hub of the first tier to the first DS port of the hub of the third tier via the second DS port of the hub of the second tier”.

FIG. 8 is a flowchart showing judgment processing executed by the judgment circuit 222. When Hub Depth of an SS hub 200 is 4, that is, the SS 200 hub is a hub located in the fifth tier (the number of hub tiers N is 5) (Yes at step S100), since there is no possibility that the hub is connected to any DS port of the SS hub 200, the judgment circuit 222 judges that object devices regarding all received packets are directly-beneath type apparatuses (at step S102).

When Hub Depth of the SS hub 200 is any of 0 to 3 (the number of hub tiers N is any of 1 to 4), and a value corresponding to a hub in “N+1”th tier in the Route String of the transfer request packet is 0, the judgment circuit 222 judges that an object device regarding the transfer request packet is a directly-beneath type apparatus (No at step S100, Yes at step S110, and step S102).

On the other hand, when a value corresponding to a hub in “N+1” th tier in Route String of the transfer request packet is 1 or larger at step 110, the judgment circuit 222 judges that the object device regarding the transfer request packet is not a directly-beneath type apparatus (No at step S100, No at step S102, and step S112).

The operation of the control circuit 220 based on the judgment result made by the judgment circuit 222 is as described above.

Although the SS hub 200 can know the power states of individual DS ports (equal to the power states of the US ports of apparatuses connected to the individual DS ports), if a hub is connected to one of the DS ports, the SS hub 200 cannot know the power state of a destination device that is connected via the hub. Therefore, if the SS hub 200 itself transmits a transfer enable packet in response to a transfer request packet transmitted from the host as the SS hub 100 does, the hubs connected to the DS port in the successive tiers return transfer deferment packets again in a similar way, which may decrease transfer efficiency.

The SS hub 200 judges whether an object device of the transfer request packet transmitted from the host is a directly-beneath type apparatus of the SS hub 200 or not, and only when it is judged that the object device is the directly-beneath type apparatus, the SS hub 200 spontaneously transmits a transfer enable packet to the host, therefore the above-mentioned problem of deterioration of transfer efficiency can be prevented from occurring.

A method for judging whether an object device of a transfer request packet is a directly-beneath type apparatus or not is not limited to the above-mentioned method. For example, the SS hub obtains device configuration information (Device Descriptor) among information exchanged between a host and a USB 3.0 apparatus at the time of enumeration executed when the USB 3.0 apparatus (a hub or a device) is connected to the DS port of the SS hub itself, and reserves the device configuration information in association with the DS port. Since Device Descriptor includes information whether the USB 3.0 apparatus is a hub or a device, the SS hub can grasp the fact that a USB 3.0 apparatus connected to each DS port is a hub or a device.

Accordingly, an object device of a transfer request packet regarding a DS port to which a device is connected is judged to be a directly-beneath type apparatus, and an object device of a transfer request packet regarding a DS port to which a hub is connected is judged not to be a directly-beneath type apparatus.

In addition, the SS hub reserves an address that the host gives to a USB 3.0 apparatus among information exchanged between the host and the USB 3.0 apparatus in association with a DS port of the SS hub itself at the time of enumeration executed when the USB 3.0 apparatus is connected to the DS port. Afterward, an SS hub judges that an object device of a transfer request packet is a directly-beneath type apparatus, if the address of the destination device of the transfer request packet coincides with the address of a USE 3.0 apparatus connected to a DS port of the SS hub itself, and the SS hub judges that the object device of the transfer request packet is not a directly-beneath type apparatus, if the address of the destination device of the transfer request packet does not coincide with the address of a USE 3.0 apparatus connected to a DS port of the SS hub itself.

### Third Embodiment

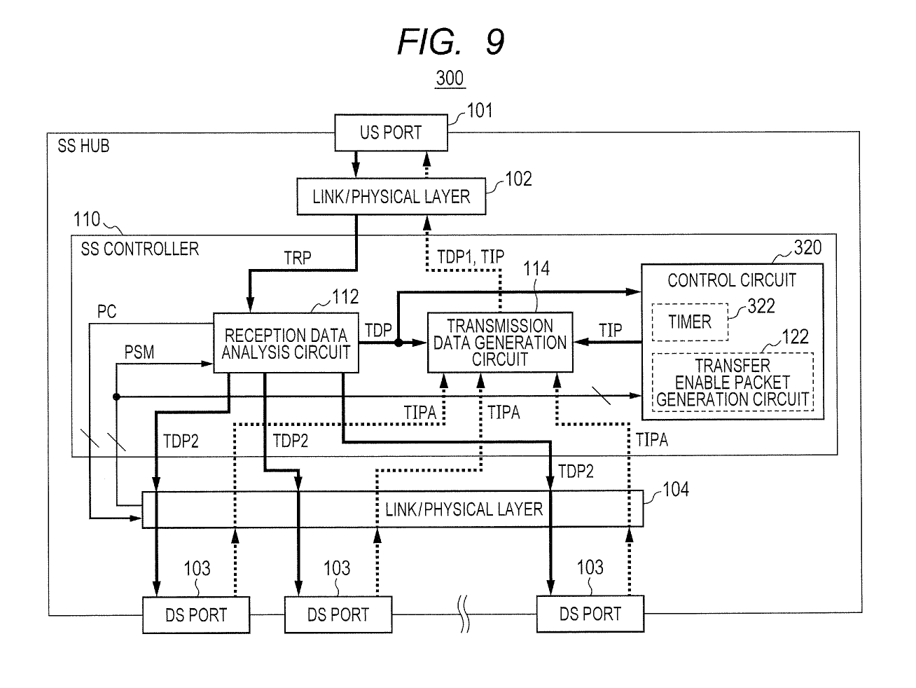

FIG. 9 is a block diagram showing an SS hub 300 according to a third embodiment. The SS hub 300 is the same as the SS hub 100 except that the SS hub 300 includes a control circuit 320 instead of the control circuit 120 of the SS hub 100.

The control circuit 320 does not prevent a reception data analysis circuit 112 from transmitting a second transfer deferment packet TDP2, and transmits a transfer enable packet TIP generated by the control circuit 320 itself to a host if the transfer enable packet is not issued by an object device even after a predefined time elapses since a timer 322 begins timing after the second transfer deferment packet TDP2 is transmitted. In order to distinguish a transfer enable packet issued by the object device from the transfer enable packet issued by the control circuit 320, the transfer enable packet issued by the object device is shown by TIPA.

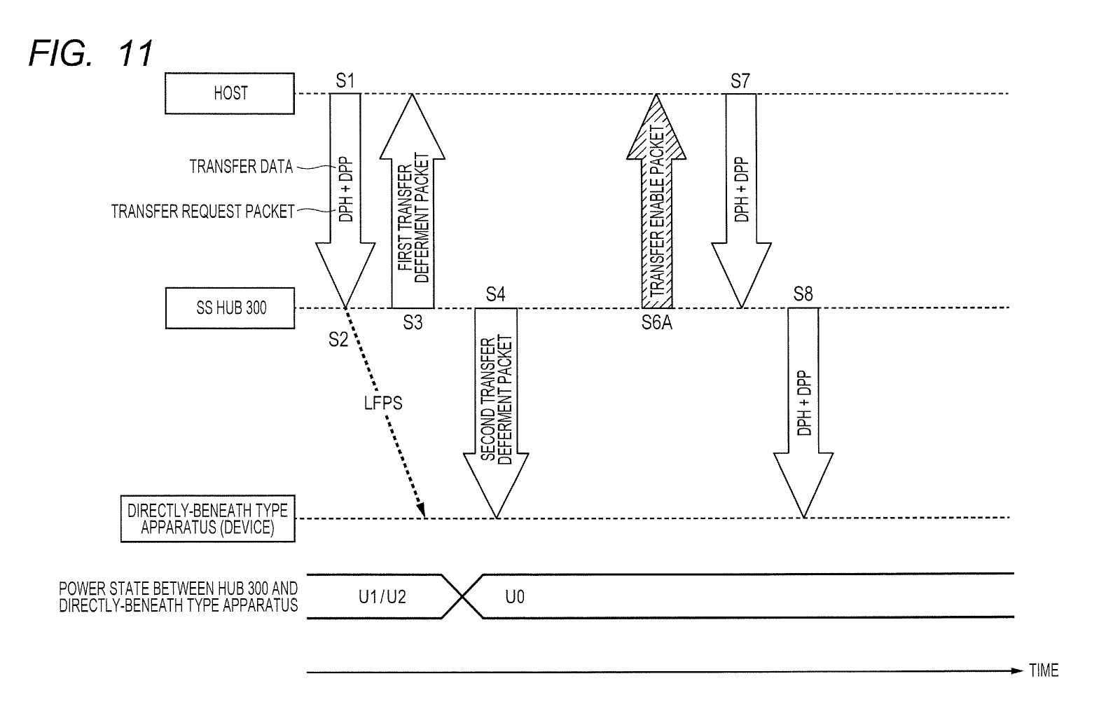

FIG. 10 and FIG. 11 are respectively a flowchart showing an IN transfer and a flowchart showing an OUT transfer. Here, the SS hub 300 operates in the same way as specified by the USB 3.0 specification in the case where the SS hub 300 receives the transfer enable packet from the object device before the predefined time elapses.

As is the case with the SS hub 100, in the case of the SS hub 300, the power consumption of the USB 3.0 hub can be suppressed, and at the same time, interconnection between the USB 3.0 hub and USB 3.0 devices can be strengthened.

The SS hubs according to the above-described embodiments are respectively included in the USB 3.0 hub, and the depiction of the figure of the USB 3.0 hub including each SS hub will be omitted. In addition, information processing instruments including these USB 3.0 hubs also fall within the scope of the present invention. Examples of the information processing instruments will be explained using a fourth embodiment and a fifth embodiment.

### Fourth Embodiment

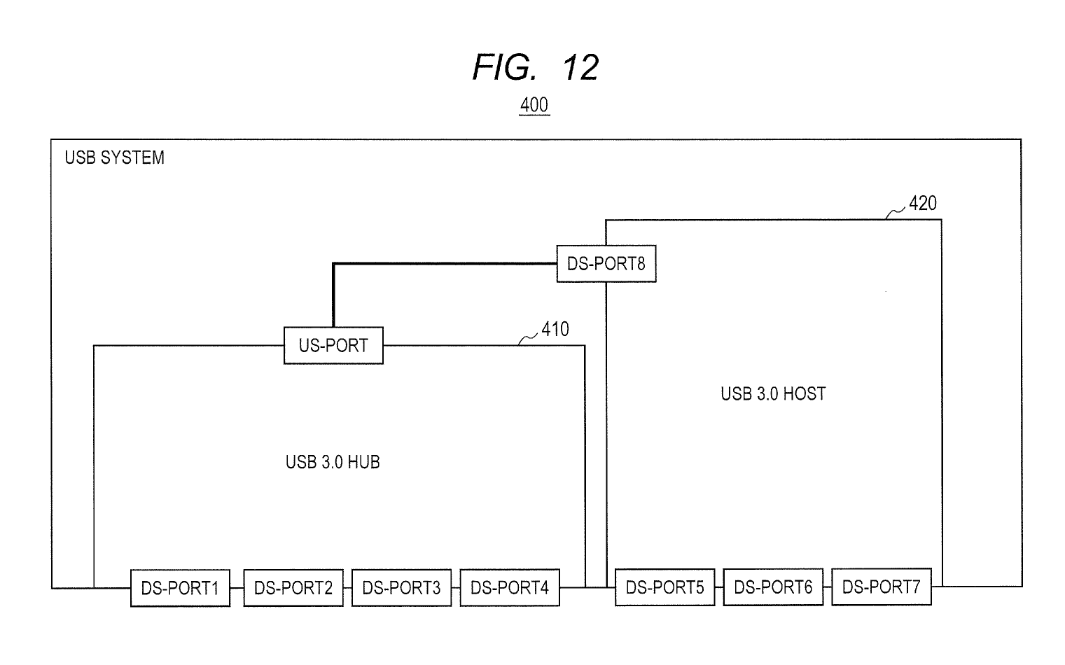

A USB system 400 shown in FIG. 12 is an expanded version of a USB port of a personal computer, and includes a USB 3.0 hub 410 and a USB 3.0 host 420.

A Super Speed hub in the USB 3.0 hub 410 is any of the above-described SS hub 100, SS hub 200, and SS hub 300, and includes one US port and four DS ports.

The USB 3.0 host 420 includes four DS ports, and one of the four DS ports is connected to the US port of the USB 3.0 hub 410. From a viewpoint of a user of a personal computer including the USB system 400, it can be said that the personal computer includes seven USB ports.

In this case, only one USB 3.0 host is specified for the USB 3.0 hub 410. This means that the minimum time (above-mentioned T2) of time intervals of packet transmission/reception performed by the USB 3.0 host can be specified as the value of one of capabilities of the USB 3.0 host. Therefore, it becomes possible that the SS hub in the USE 3.0 hub 410 generates a transfer enable packet by itself, and adjusts a timing in which the SS hub transmits the transfer enable packet to the host, so that transfer efficiency can be improved more precisely. Further, the size of the control circuit can be reduced by reserving this value as a fixed value instead of reserving this value in a register.

### Fifth Embodiment

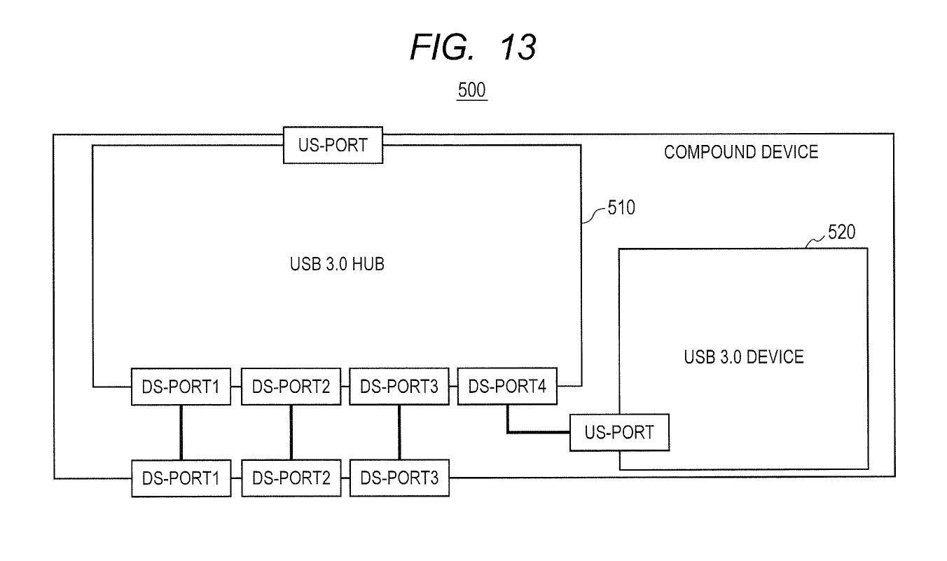

FIG. 13 is a block diagram showing a compound device 500 according to a fifth embodiment. The compound device 500 includes a USB 3.0 hub 510 and a USB 3.0 device 520.

A Super Speed hub in the USB 3.0 hub 510 is any of the above-described SS hub 100, SS hub 200, and SS hub 300, and includes one US port and four DS ports.

The USB 3.0 device 520 is a peripheral device such as a display or a keyboard, and it includes a US port. The US port is connected to one of DS ports of the USB 3.0 hub 510.

In the case of such a compound device, the USB 3.0 device 520 is always-connected to the USB 3.0 hub 510, and the time T1 (the maximum time needed for the USB 3.0 device to return from U1 state or U2 state to U0 state) can be specified. Therefore, as is the case of the USB system 400 according to the fourth embodiment, transfer efficiency is improved more precisely.

Although the present invention made by the inventors has been described on the basis of the embodiments of the present invention, it goes without saying that the present invention is not limited to the above embodiments of the present invention, and various modifications may be made without departing from the gist of the present invention.

For example, the present invention can be applied not only to a hub of a USB system in which transfer deferment processing specified in USB 3.0 is executed, but also can be applied to a hub of a USB system in which transfer deferment processing that is similar to that specified in USB 3.0 and is specified in USB 3.1 or the like is executed.

What is claimed is:

1. An SS (Super Speed) hub installed in a USB (Universal Serial Bus) 3.0 hub, comprising at least one DS ports; and an SS controller,
wherein, when the SS controller receives a transfer request packet, which requests an object device that is a downstream USB device to transmit data, from a host, if a DS port that is in charge of transmitting the transfer request packet downstream among the DS ports, and a directly-beneath type apparatus, which is a USB apparatus directly connected to the DS port, are in a low power consumption state,
the SS controller
makes the DS port transmit a return signal for returning the DS port and the directly-beneath type apparatus to a data transmission/reception enable state,
generates a transfer enable packet, which indicates that the object device has become ready to correspond to the data transfer,
transmits the transfer enable packet to the host after transmitting a first transfer deferment packet, which informs the host of the deferment of the data transfer, to the host, and
does not transfer a second transfer deferment packet indicating the deferment of the data transfer to the object device after the DS port and the directly-beneath type apparatus return to the data transmission/reception enable state.

2. The SS hub according to claim 1,
wherein the SS controller generates the transfer enable packet from the transfer request packet, and sets NumP in the transfer enable packet to “1”.

3. The SS hub according to claim 1,
wherein, if the directly-beneath type apparatus is in the low power consumption state when the SS controller receives the transfer request packet from the host,
the SS controller judges whether the object device is the directly-beneath type apparatus or not, and if it is judged that the object device is not the directly-beneath type apparatus, the SS controller executes a process in the same way as specified by the USB specification.

4. The SS hub according to claim 3,
wherein the SS controller judges whether the object device is the directly-beneath type apparatus or not on the basis of Hub Depth in the SS hub and Route String included in the transfer request packet.

5. The SS hub according to claim 4,
wherein the SS controller judges that the object device is the directly-beneath type apparatus if Hub Depth of the SS hub shows the lowest tier specified by the USB specification.

6. The SS hub according to claim 3,
wherein the SS controller reserves Device Descriptors that show whether the directly-beneath type apparatuses of all the DS ports of the SS hub are respectively hubs or devices, and
if a directly-beneath type apparatus of the DS port in charge of transmitting the transfer request packet downstream is a device, the SS controller judges that the object device is the directly-beneath type apparatus.

7. The SS hub according to claim 3,
wherein the SS controller reserves Device Addresses of the directly-beneath type apparatuses of all the DS ports of the SS hub, and
on the basis of whether the Device Address of the destination device of the transfer request packet and the Device Address of a directly-beneath type apparatus of the DS port in charge of transmitting the transfer request packet downstream coincide with each or not, the SS controller judges whether the object device is the directly-beneath type apparatus or not.

8. The SS hub according to claim 1,
wherein the SS controller transmits the transfer enable packet to the host when the directly-beneath type apparatus transits to Recovery state.

9. The SS hub according to claim 1,
wherein the SS controller transmits the transfer enable packet to the host when a predefined time elapses after the SS controller transmits the first transfer deferment packet to the host.

10. An SS (Super Speed) hub installed in a USB (Universal Serial Bus) hub, comprising at least one DS port; and an SS controller,
wherein, when the SS controller receives a transfer request packet, which requests an object device that is a downstream USB device to transmit data, from a host, if a DS port that is in charge of transmitting the transfer request packet downstream among the one or more DS ports, and a directly-beneath type apparatus, which is a USB apparatus directly connected to the DS port, are in a low power consumption state,
the SS controller
makes the DS port transmit a return signal for returning the DS port and the directly-beneath type apparatus to a data transmission/reception enable state; and
transmits a first transfer deferment packet, which informs the host of the deferment of the data transfer, to the host;
at the same time, transmits a second transfer deferment packet to the object device after the DS port and the directly-beneath type apparatus return to the data transmission/reception enable state; and
afterward, if the SS controller does not receive a transfer enable packet indicating that the object device has become ready to correspond to the data transfer from the object device even after a predefined time elapses, the SS controller generates the transfer enable packet by itself, and transmits the transfer enable packet to the host.

11. A USB hub comprising an SS hub described in claim 1.

12. An information processing instrument in which the USB hub according to claim 11 is embedded.

13. A USB hub apparatus comprising:
a downstream port that transmits and receives data to and from at least one USB peripheral device;
an upstream port that transmits and receives data to and from a USB host apparatus; and
a controller that receives a data transfer request packet from the USB host apparatus, instructs a USB peripheral device that is a destination device of the data transfer request to transfer data via the downstream port,
wherein, when the controller receives the data transfer request packet, if the USE peripheral device, which is the destination device of the data transfer request, and a downstream port corresponding to the USE peripheral device are in a low power consumption state,
the controller transmits a return control signal to the USE peripheral device and to the corresponding downstream port, and after transmitting a first transfer deferment packet to the USE host apparatus via the upstream port, the controller generates a first transfer enable packet indicating that the USB peripheral device can correspond to data transfer on the basis of the first transfer deferment packet, and transmits the first transfer enable packet to the USB host apparatus.

14. The USE hub apparatus according to claim 13,
wherein the controller generates the first transfer enable packet and transmits the first transfer enable packet to the USB host apparatus regardless of whether the controller receives a second transfer enable packet transmitted by the USB peripheral device or not.

15. The USB hub apparatus according to claim 13,
wherein the controller transmits the first transfer enable packet to the USB host apparatus after the USB peripheral device and the corresponding downstream port become in a data transmission/reception enable state in response to the return control signal.

16. The USB hub apparatus according to claim 13,
wherein the controller does not transmit a second transfer deferment packet to the USB peripheral device after the USB peripheral device and the corresponding downstream port become in a data transmission/reception enable state in response to the return control signal.
